(19) United States
(12) Patent Application Publication
(10) Pub. No.: US 2015/0006521 A1
(43) Pub. Date: Jan. 1, 2015

(54) TEXT ABSTRACT EDITING SYSTEM, TEXT ABSTRACT SCORING SYSTEM AND METHOD THEREOF

(71) Applicant: NATIONAL YUNLIN UNIVERSITY OF SCIENCE AND TECHNOLOGY, Yunlin County (TW)

(72) Inventor: Yu-Fen YANG, YUNLIN COUNTY (TW)

(21) Appl. No.: 14/315,348

(22) Filed: Jun. 26, 2014

(30) Foreign Application Priority Data
Jul. 1, 2013 (TW) 102123486

(51) Int. Cl. G06F 17/30

(52) U.S. Cl. CPC G06F 17/30634
USPC 707/723

(57) ABSTRACT

The text scoring system includes a text providing module, a text dividing module, a searching module, a choosing module, a receiving module and a comparing module. The text providing module is for providing an original text. The text dividing module is for dividing the original text into terms. The searching module is for searching a plurality of first related terms. The choosing module can calculate the related degree between each first related term and the terms of the original text, wherein the first related term with the maximum related degrees is the substance of the original text. The receiving module can receive a user's text. The comparing module is for checking whether the user's text includes the substance. As such, the text abstract scoring system can examine whether the user understands the meaning of the original text or not.

### RELATED APPLICATIONS

This application claims priority to Taiwan Application Serial Number 102123486, filed Jul. 1, 2013, which is herein incorporated by reference.

### BACKGROUND

1. Technical Field

The present invention relates to a computer educating tool. More particularly, the present invention relates to a text scoring system.

2. Description of Related Art

With the rapid development of high tech and the Internet has become popular, in addition to the office and social, school only has popularize online education for providing students a new type of study. Thus, students can not only receive more and immediate information through the Internet, but also increase the efficiency of study by distance learning and hand in the home work online.

In general, students are asked to write a substance and an abstract as homework after reading an article, and teacher can check whether students understand the content of the article through the homework. However, when one teacher has to teach many students, the quantity of the homework is also excessive, and the teacher cannot detailed teach and give some precise suggestion to every student. Besides, it is difficult for teacher to provide an abstract or key point of every article for student.

### SUMMARY

According to one aspect of the present disclosure, a text abstract scoring system includes a text providing module, a text dividing module, a searching module, a choosing module, a receiving module and a comparing module. The text providing module is for providing an original text. The text dividing module is for dividing the original text into a plurality of terms. The searching module is connected to a first external database, and the searching module includes a first searching module for searching a plurality of first related terms from the first external database according to each of the terms. The choosing module is connected to the searching module, and the choosing module includes a first calculating module for calculating a first related degree between each of the first related terms and each of the terms of the original text, wherein the first related terms corresponding to a maximum first related degree is a substance of the original text. The receiving module is for receiving at least one user's text. The comparing module is for checking whether the user's text has the substance, and providing a comparing result.

According to another aspect of the present disclosure, a text abstract scoring method includes, providing an original text, wherein the original text has a plurality of paragraphs; dividing the original text into a plurality of terms; searching a plurality of first related terms from the first external database according to each of the terms, and calculating a first related degree between each of the first related terms and each of the terms of the original text, wherein the first related terms corresponding to a maximum first related degree is a substance of the original text; searching a plurality of second related terms from the first external database according to the substance, and calculating a second related degree between each of the second related terms and the terms of each of the paragraphs, wherein in each paragraph the second related term corresponding to a maximum second related degree is a paragraph substance of the paragraph; choosing the terms from the first related terms and the second related terms except the substance and the paragraph substances as a plurality of paragraph related terms; receiving at least one user's text; and comparing whether the user's text has the substance, the paragraph substances and the paragraph related terms, and providing a comparing result.

According to another aspect of the present disclosure, a text abstract editing system includes a text providing module, a text dividing module, a first searching module, a first calculating module, a second searching module, a second calculating module, a sentence choosing module, and an abstract editing module. The text providing module is for providing an original text, wherein the original text has a plurality of paragraphs. The text dividing module is for dividing the original text into a plurality of terms. The first searching module is for searching a plurality of first related terms from the first external database according to each of the terms. The first calculating module is for calculating a first related degree between each of the first related terms and each of the terms of the original text, wherein the first related terms corresponding to a maximum first related degree is a substance of the original text. The second searching module is for searching a plurality of second related terms from the first external database according to the substance. The second calculating module is for calculating a second related degree between each of the second related terms and the terms of each of the paragraphs, wherein in each paragraph the second related term corresponding to a maximum second related degree is a paragraph substance of the paragraph. The sentence choosing module is for calculating a sentence related degree between each of a plurality of sentences of each paragraph and the paragraph substance thereof, wherein the sentence corresponding to a maximum sentence related degree is a main sentence of each paragraph. The abstract editing module is for composing the main sentence of each paragraph into an abstract, wherein a sequence of each main sentence in the abstract corresponds to a sequence of the paragraphs in the original text, and a title of the abstract is the substance.

### BRIEF DESCRIPTION OF THE DRAWINGS

The invention can be more fully understood by reading the following detailed description of the embodiment, with reference made to the accompanying drawings as follows:

FIG. 1 shows a block diagram of a text abstract scoring system according to an embodiment of the present disclosure;

FIG. 2 shows a block diagram of a text abstract scoring system according to another embodiment of the present disclosure;

FIG. 3 shows a schematic diagram of a term mind map provided from the mind map module of the text abstract scoring system of FIG. 2;

FIG. 4 shows a flow chart of a text abstract scoring method according to further another embodiment of the present disclosure; and

FIG. 5 shows a block diagram of a text abstract editing system according to yet another embodiment of the present disclosure.

### DETAILED DESCRIPTION

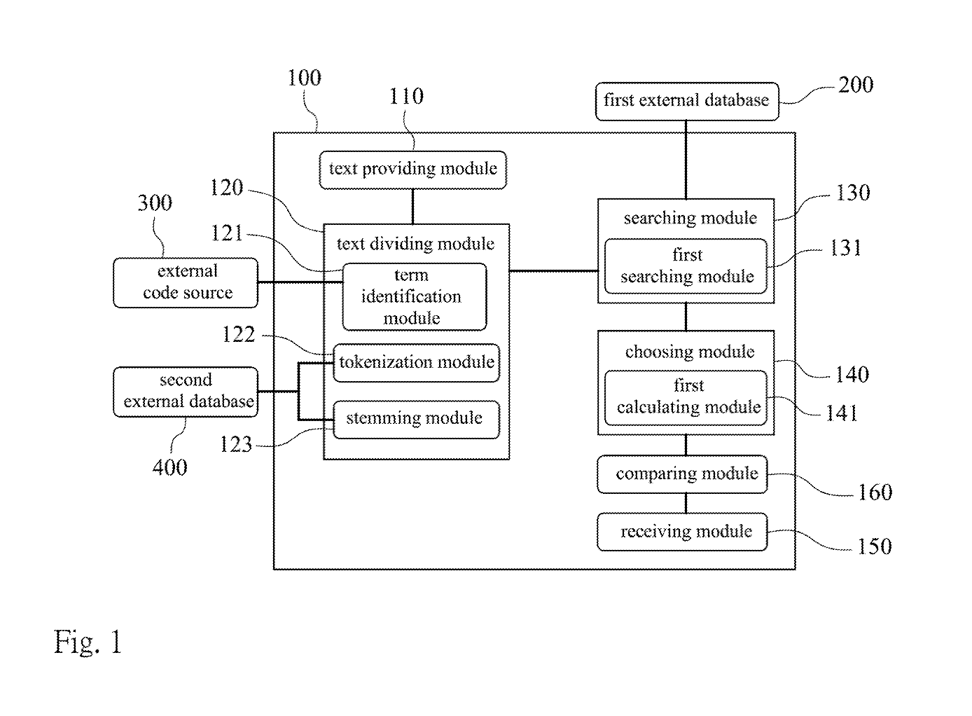

FIG. 1 shows a block diagram of a text abstract scoring system 100 according to an embodiment of the present disclosure. The text abstract scoring system 100 can be applied to Internet, and connected to a first external database 200.

In FIG. 1, the text abstract scoring system 100 includes a text providing module 110, a text dividing module 120, a searching module 130, a choosing module 140, a receiving module 150 and a comparing module 160. The text providing module 110 is connected to the text dividing module 120, the text dividing module 120 is connected to the searching module 130, the searching module 130 is connected to the choosing module 140 and the first external database 200, and the comparing module 160 is connected to the choosing module 140 and the receiving module 150.

In detail, the text providing module 110 is for providing an original text. The original text can be a text in English, which can have a plurality of paragraphs. The user can read the original text.

The text dividing module 120 is for dividing the original text into a plurality of terms. For dividing the original text into exactly terms, the text dividing module 120 can further includes a term identification module 121, a tokenization module 122 and a stemming module 123. The term identification module 121, such as part-of-speech Noun identification, is for identifying a language of the original text. The tokenization module 122 is for dividing character streams of the original text into a plurality of pre-terms and classifying the pre-terms. The stemming module 123 is for certainly dividing the pre-terms into the terms of the original text. For an example, the term identification module 121 can be connected to an external code source 300, such as LingPipe, FreeLing, openNLP, etc, so that the term identification module 121 can certainly identifying the language of the original text. The tokenization module 122 and the stemming module 123 can be connected to a second external database 400, wherein the second external database 400 can be a lexical database, such as WorldNet which include a great quantity of definition of words and phrases, superordinate relation or subordinate relation (also called hyperonymy relation or hyponymy relation), relative words, etc. Therefore, the tokenization module 122 can divide character streams of the original text into a plurality of pre-terms and classify the pre-terms according to the second external database 400, and the stemming module 123 can certainly divide the pre-terms into the terms of the original text.

The following statement is part of paragraph of an original text, which is certainly classified and divided into a plurality of terms via the term identification module 121 the tokenization module 122 and the stemming module 123 of the text dividing module 120.
It<pps> sure<rb> sounds<vbz> glamorous<jj>, but<cc>these<dts> one-person<nn> startups<nns> are<ber>more<ql> demanding<vbg> than<cs> they<ppss> appear<vb>.
   Wherein, the symbol “< >” is for dividing each term, and the content in the symbol “< >” is the classification of each term. The content of the classification for classifying terms is used in common by the conventional lexical database, and a person of ordinary skill in the art is familiar with the classification, hence, the content of the classification will not detailed introduce herein.

Furthermore, the text dividing module 120 can also recognize that different terms in the original text are the same entity. For an example, a paragraph of one original text is stated that,
“I have a sister. Her name is Mary. She is a junior high school student.”
   the text dividing module 120 can recognize that the terms “a sister”, “her”, “Mary”, “she”, “a junior high school student” are represent the same person “Mary”. Therefore, the original text can be divided into terms precisely.

The searching module 130 connected to the first external database 200 includes a first searching module 131, wherein the first searching module is for searching a plurality of first related terms from the first external database 200 according to each of the terms. In detail, the first external database 200 can be chose from a variety of databases on demand, such as Wikipedia, and the first related terms related to each terms can be searched and obtained from the first external database 200. Furthermore, the first searching module 131 can be connected to the first external database 200 via a connecting platform, such as Yahoo. Query Language (YQL), etc., which can select the terms searched from the first searching module 131, so that the quantity of the first related terms would not be excessive and the first related terms can be snore precise.

The choosing module 140 includes a first calculating module 141 for calculating a first related degree between each of the first related terms and each of the terms of the original text, wherein the first related terms corresponding to a maximum first related degree is a substance of the original text. In detail, the calculating conditions (1) and (2) for obtaining the first related degrees are stated as follow:

$$\begin{matrix}score ( term ) = {tf}_{i} ( term ) * 0.5 + {\sum }_{excepti}^{ } tf ( term ) * 0.3 & ( 1 ) \\ score ( phrase ) = {tf}_{i} ( phrase ) * 1 + {\sum }_{excepti}^{ } tf ( phrase ) * 0.6 & ( 2 )\end{matrix}$$

### Wherein,

tfᵢ is times of appearance of a first related terms in the i-th paragraph of the original text; and

$${\sum }_{excepti}^{ } tf$$

is times of appearance of aforementioned first related terms in others paragraph except of the i-th paragraph,

Each of the first related terms can be a word or a phrase, hence, the foregoing calculating condition (1) can provide the importance of a word to the original text, and the foregoing calculating condition (2) can provide the importance of a phrase to the original text. In general, the phrase is more meaningful than the word, so that the weight of the phrase in the foregoing calculating condition (2) is larger than the weight of the word in the foregoing calculating condition (1).

Moreover, the first calculating module 141 can calculate a first related degree between each of the first related terms and each of the terms of the original text via the calculating condition (3) as follows.

$$w = arg {max}_{i} ( {T}_{i} + \frac{{TF}_{i}}{ParaNum} ) \qquad ( 3 )$$

### Wherein,

Tᵢ represents whether the first related term in the title of the original text. When the first related term is in the title of the original text, Tᵢ is 1; when the first related term is not in the title of the original text, Tᵢ is 0;
TFᵢ represents the number of times the first related term appears in the original text; and
ParaNum represents a number of the paragraphs in the original text.

The foregoing calculating condition (3) provides the first related degree between each of the first related terms and each of the terms of the original text, wherein the first related terms corresponding to a maximum first related degree is a substance of the original text.

The receiving module 150 is for receiving at least one user's text. In this embodiment of the present disclosure, the user can upload a reading review to the text abstract scoring system after reading the original text.

The comparing module 160 is for checking whether the user's text has the substance provided from the first calculating module 141 of the choosing module 140, and providing a comparing result. That is, the comparing module 160 can provide an answer whether the user's text has the substance. From the teaching perspective, the user catches the key point of the original text when the user's text has the substance. Otherwise, if the user's text does not have the substance, the user misunderstand the meaning of the original text. Therefore, Teacher can adjust the way of teaching in order to improve the ability of study, comprehension and writing of the user (Student).

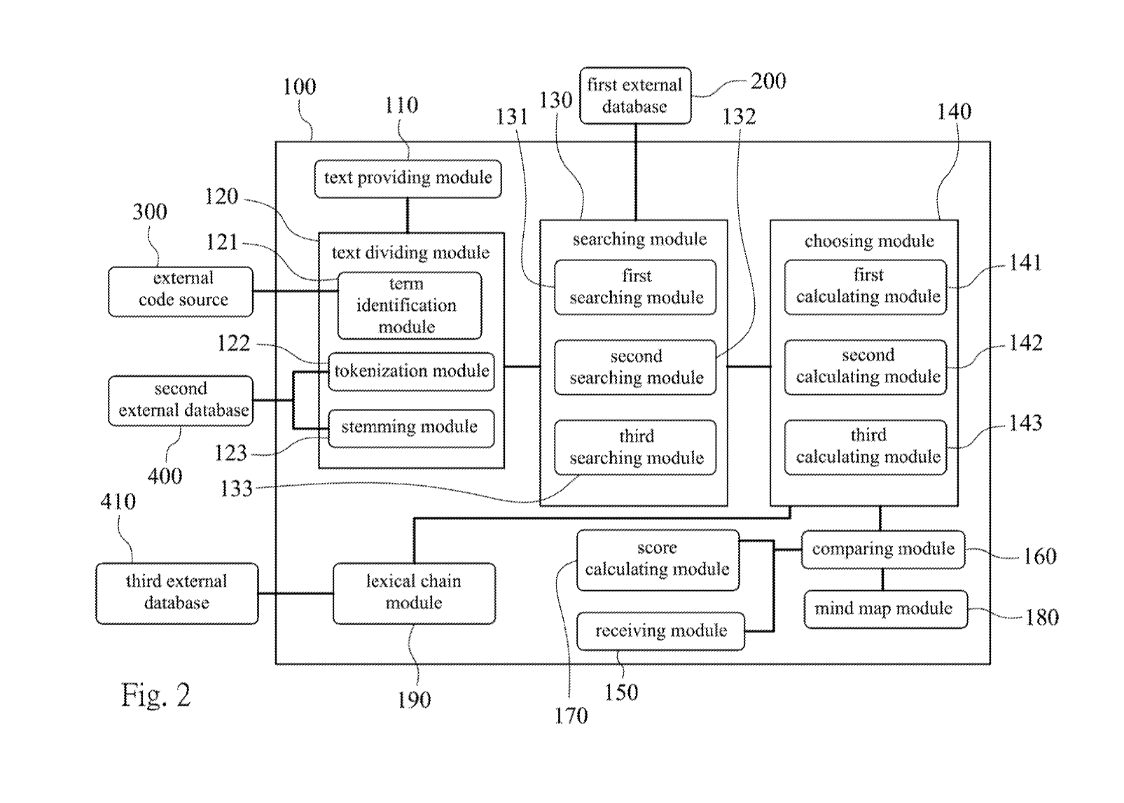

FIG. 2 shows a block diagram of a text abstract scoring system 100 according to another embodiment of the present disclosure. In FIG. 2, the text abstract scoring system 100 further includes a score calculating module 170 and a mind map module 180, wherein the score calculating module 170 is connected to the comparing module 160, and the mind map module 180 is connected to the choosing module 140. Further, the searching module 130 further includes a second searching module 132 and a third searching module 133, and the choosing module 140 further includes a second calculating module 142 and a third calculating module 143. In the searching module 130, the second searching module 132 is connected to the first searching module 131, and the third searching module 133 is connected to the second searching module 132. In the choosing module 140, the second calculating module 142 is connected to the first calculating module 141, the third calculating module 143 is connected to the second calculating module 142.

In detail, the second searching module 132 is for searching a plurality of second related terms from the first external database 200 according to the substance, wherein the searching processes of the second searching nodule 132 and the first searching module 131 in the embodiment of FIG. 1 are the same, and will not describe again herein.

The second calculating module 142 of the choosing module 140 is for calculating a second related degree between each of the second related terms and the terms of each of the paragraphs, wherein in each paragraph the second related term corresponding to a maximum second related degree is a paragraph substance of the paragraph.

The second calculating module 142 can obtain the paragraph substance of each paragraph via the calculating condition (4) as follow.

$${term}_{ij} = {PF}_{ij} * ( \frac{{PF}_{ij}}{{TF}_{ij}} ) + Log ( {OPF}_{i} * ( \frac{{OPF}_{ij}}{{P}_{j}} ) + 1 ) + {DC}_{j} + {PC}_{ij} \\ {DC}_{j} = compare ( {C}_{d} , {term}_{j} ) = \{ \begin{matrix}1 , & {C}_{d} = {term}_{j} \\ 0 , & {C}_{d} \neq {term}_{j}\end{matrix} \\ {PC}_{ij} = compare ( {C}_{k} , {term}_{j} ) = \{ \begin{matrix}1 , & {C}_{k} = {term}_{j} \\ 0 , & {C}_{k} \neq {term}_{j}\end{matrix} \qquad ( 4 )$$

### Wherein

PFᵢⱼ represents times of appearance of the second related term j in the i-th paragraph;
TFⱼ represents times of appearance of the second related term j in the original text;
OPFᵢⱼ represents times of appearance of the second related term j in the original text except the aforementioned i-th paragraph
Pⱼ represents times of appearance of the second related term j in different paragraphs, for an example, when the times of appearance of the second related term j in the 1st paragraph is 2, the times of appearance of the second related term j in the 2nd paragraph is 1, the times of appearance of the second related term j in the 3rd paragraph is 0, then Pⱼ=2 (the second related term j appear in the 1st and 2nd paragraph;

DCⱼ represents whether the second related term j is one of the related terms of the original text; when the answer is yes, DCⱼ=1; when the answer is no, DCⱼ=0; and

PCᵢⱼ represents whether the second related term is one of the related terms of the paragraphs; when the answer is yes, PCᵢⱼ=1; when the answer no, PCᵢⱼ=0.

The aforementioned related terms of the original text and related terms of the paragraphs is searched from the words and sentenced of the original text, and is certainly divided into related terms from the text dividing module 120.

From the aforementioned calculating condition (4), the second related term corresponding to the maximum of termᵢⱼ is the paragraph substance of the paragraph.

After obtain the paragraph substance of each paragraph, the comparing module 160 can checking whether each of the user's paragraphs of the user's text has the paragraph substance, and providing a paragraph comparing result.

Furthermore, the third searching module 133 of the searching module 130 is for receiving the first related terms from the first searching module 131 and the second related terms from the second searching module 132.

The third calculating module 143 of the choosing module 140 is for choosing the terms from the first related terms and the second related terms except the substance and the paragraph substances as a plurality of paragraph related terms, which can be regarded as supporting ideas.

The comparing module 160 can further check whether each of the user's paragraphs has the paragraph related terms, and provide a paragraph related terms comparing result.

In other words, the first calculating module 141 choose the terms corresponding to a maximum first related degree as the substance based on the original text. The second calculating module 142 choose the second related term corresponding to a maximum second related degree as the paragraph substance based on each paragraph of the original text. The third calculating module 143 provides the paragraph related terms according to the results of the first searching module 131 the first calculating module 141, the second searching module 132 and the second calculating module 142.

According to the comparing result, the paragraph comparing result and the paragraph related terms comparing result, the score calculating module 170 of the text abstract scoring system 100 can receive the comparing result, the paragraph comparing result and the paragraph related terms comparing result, and calculate a user's text score. In general, the percentage of the score of the substance and the paragraph substances are greater than the paragraph related terms. Therefore. Teacher can confirm whether the user understand the content of the original text from the score.

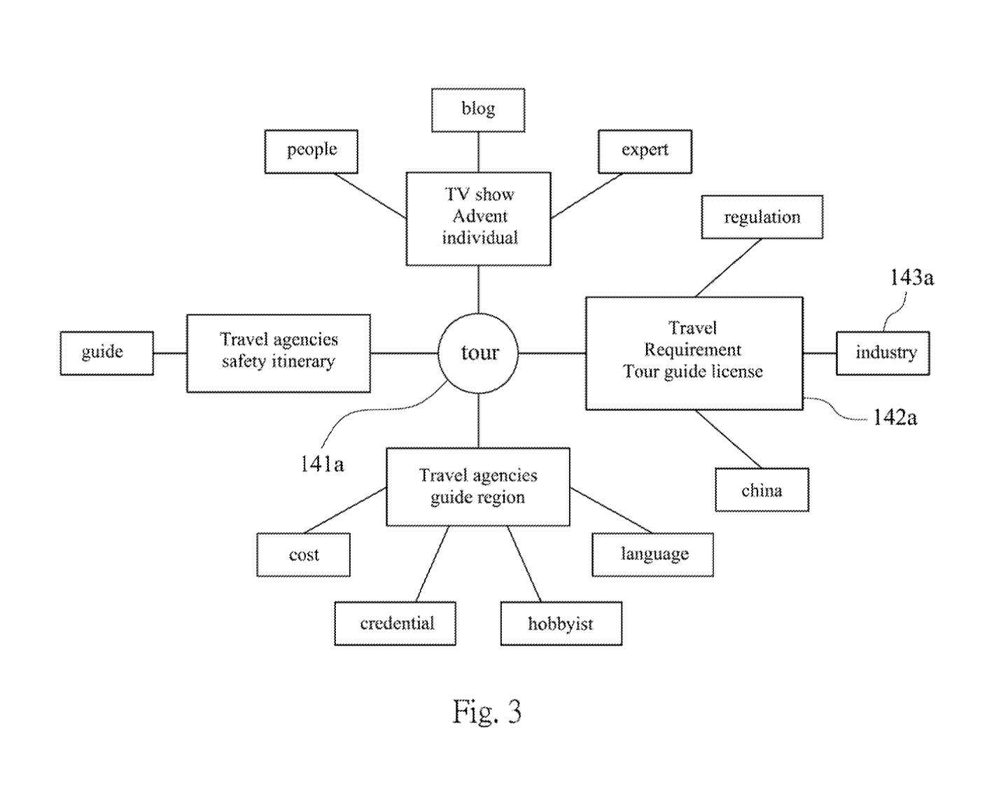

Moreover, the mind map module 180 of the text abstract scoring system 100 is for receiving the substance, the paragraph substance and the paragraph related terms, and providing a term mind map. FIG. 3 shows a schematic diagram of a term mind map provided from the mind map module 180 of the text abstract scoring system 100 of FIG. 2. In FIG. 3, the first level (innermost level) of the term mind map is a substance 141a. From innermost to outermost of the term mind map, the second level of the term mind map is paragraph substances 142a, and the third level (outermost) of the term mind map is paragraph related terms. Therefore, the user can quickly and exactly understand the point of the original text from the term mind map.

Furthermore, the text abstract scoring system 100 can include a lexical chain module 190 connected to the choosing module 140. The lexical chain module 190 is for receiving the paragraph related terms from the third calculating module 143 of the choosing module 140. The lexical chain module 190 is connected to a third external database 410, such as WordNet, which can compare that the related degree between each paragraph related term and each term of the paragraph of the original text for classifying each of the paragraph related terms. In detail, the lexical chain module 190 can classify the paragraph related terms according four types (called lexical chain types), and importance criterion of each type is presented as the number of sign “★” which shown as following table.

| Lexical chain Type | Importance |
|---|---|
| Synonym/Reiteration (same meaning) | ★★★ |
| hypernym/hyponym (generalization/specialization) | ★★ |
| Relatedsynset (derivationally related) | ★★ |
| Meronym (member-of/has-a/part-of | ★ |

The lexical chain module 190 can search whether the paragraph related terms of the four types exist in the paragraph or not. If the paragraph related term of the four types appears many times in the paragraph, the paragraph related term is considered more important. In the lexical chain module 190, the importance can be quantized into chain score as following calculating condition (5):

chain_score(tᵢ)=ns(tᵢ)*1+[nh(tᵢ)+nr(tᵢ)]*0.7+nm(tᵢ)*0.4 (5)

wherein,
ns represents the number of times that the synonyms reiterations of one paragraph related term appears in the paragraph;
nh represents the number of times that the hypernyms/hyponyms of one paragraph related term appears in the paragraph;
nr represents the number of times that the relatedsynsets (related synonym) of one paragraph related term appears in the paragraph;
nm represents the number of times that the meronyms of one paragraph related term appears in the paragraph.

If the chain score of one paragraph related term is higher, that is, the paragraph related term appears lots of synonyms, hypernyms/hyponyms, related synonym and meronyms in a paragraph, the paragraph related term has a major contribution for the meaning of the one paragraph.

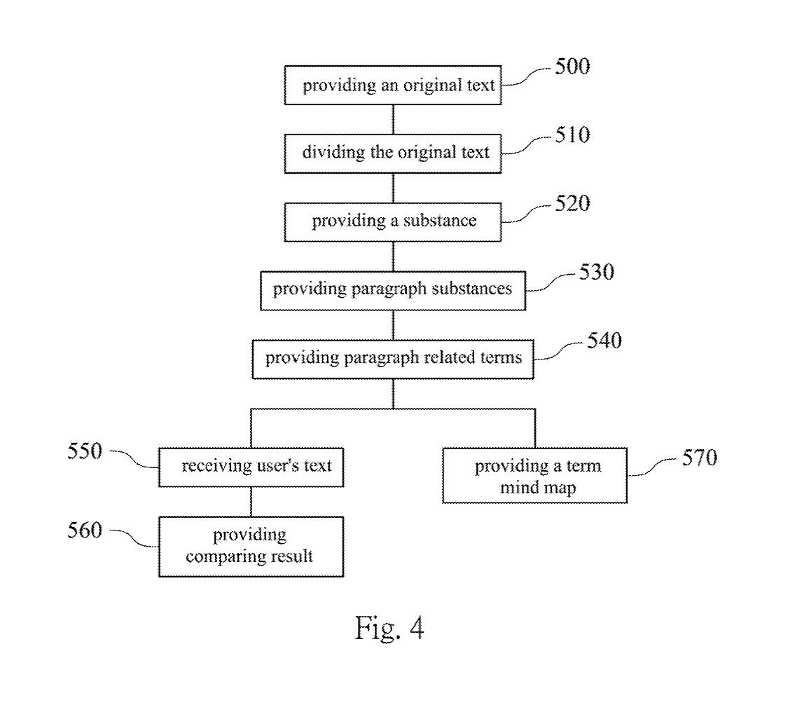

FIG. 4 shows a flow chart of a text abstract scoring method according to further another embodiment of the present disclosure. The text abstract scoring method of FIG. 4 can applied on the text abstract scoring system of FIG. 2. In FIG. 4, the text abstract scoring method includes the steps as follow.

Step 500 an original text is provided, wherein the original text has a plurality of paragraphs.

Step 510, the original text is divided into a plurality of terms.

Step 520, a plurality of first related terms is searched from the first external database according to each of the terms, and a first related degree between each of the first related terms and each of the terms of the original text is calculated, wherein the first related terms corresponding to a maximum first related degree is a substance of the original text. That is, the substance is provided.

Step 530, a plurality of second related terms is searched from the first external database according to the substance, and a second related degree between each of the second related terms and the terms of each of the paragraphs is calculated, wherein in each paragraph the second related term corresponding to a maximum second related degree is a paragraph substance of the paragraph. That is, the paragraph substances are provided.

Step 540, the terms from the first related terms and the second related terms except the substance and the paragraph substances are chose as a plurality of paragraph related terms. That is, the paragraph related terms are provided.

Step 550, at least one user's text is received.

Step 560, the user's text is compared to the substance, the paragraph substances and the paragraph related terms for checking whether the user's text has the substance, the paragraph substances and the paragraph related terms, and a comparing result is provided.

Furthermore, the text abstract scoring method can further include Step 570 the substance, the paragraph substances and the paragraph related terms can be received, and a term mind map can be provided (as shown in FIG. 3).

Therefore, the comparing result can show the level of comprehension and writing of the user. Further, the term mind map can simplified and certainly present the key point of the original text, so that the user can quickly and exactly understand the point of the original text from the term mind map.

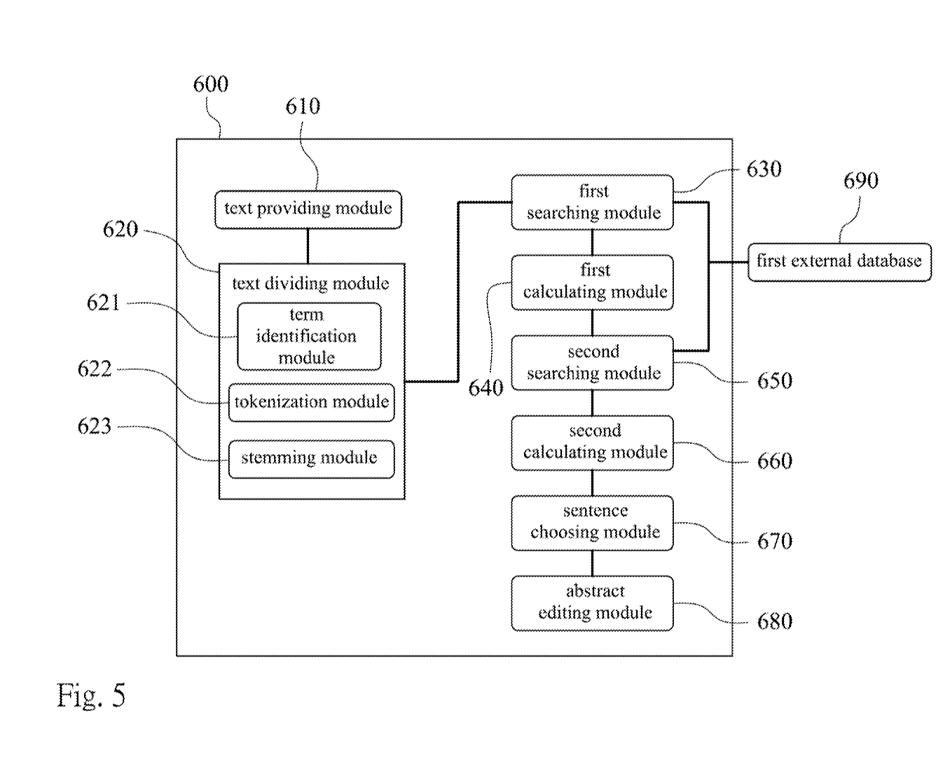

FIG. 5 shows a block diagram of a text abstract editing system 600 according to yet another embodiment of the present disclosure. In FIG. 5, the text abstract editing system 600 includes a text providing module 610, a text dividing module 620, a first searching module 630, a first calculating module 640, a second searching module 650, a second calculating module 660, sentence choosing module 670 and an abstract editing module 680.

The text providing module 610 is for providing an original text, wherein the original text has a plurality of paragraphs, and each paragraph has a plurality of sentences. The original text can be a text document built-in the text abstract editing system 600 or a text captured from external system or internet which connected with the text abstract editing system 600.

The text dividing module 620 is connected to the text providing module 610, and is for dividing the original text into a plurality of terms. The text dividing module 620 can includes a term identification module 621, tokenization module 622 and a stemming module 623, which are the same to the term identification module 121, the tokenization module 122 and the stemming module 123 in FIG. 1, and will not be described again herein.

In FIG. 5, the first searching module 630 is connected to the text dividing module 620, and is for searching a plurality of first related terms from the first external database 690 according to each of the terms of the original text. The first calculating module 640 is connected to the first searching module 630, and is for calculating a first related degree between each of the first related terms and each of the terms of the original text, wherein the first related terms corresponding to a maximum first related degree is a substance of the original text.

The second searching module 650 is for searching a plurality of second related terms from the first external database 690 according to the substance, wherein the second searching module 650 is connected to the first calculating module 640. Then, the second calculating module 660 connected to the second searching module 650 is for calculating a second related degree between each of the second related terms and the terms of each of the paragraphs, wherein in each paragraph the second related term corresponding to a maximum second related degree is a paragraph substance of the paragraph. The detail of the first searching module 630, the first calculating module 640, the second searching module 650 and the second calculating module 660 is the same with the embodiments of FIGS. 1 and 2, and will not be described again herein.

In the embodiment of FIG. 5, the text abstract editing system 600 includes the sentence choosing module 670 connected to the second calculating module 660 is for calculating a sentence related degree between each of a plurality of sentences of each paragraph and the paragraph substance thereof, wherein the sentence corresponding to a maximum sentence related degree is a main sentence of each paragraph. Therefore, the sentence choosing module 670 can capture a main sentence from each paragraph of the original text.

Furthermore, the abstract editing module 680 connected to the sentence choosing module 670 is for composing the main sentence of each paragraph into an abstract, wherein a sequence of each main sentence in the abstract corresponds to a sequence of the paragraphs in the original text, and a title of the abstract is the substance. Therefore, the text abstract editing system can provide the abstract of the original text according to the main sentences of the paragraph and the sequence of each paragraph of the original text. Therefore, the user can read the abstract provided from the text abstract editing system 600 for understanding the main idea of the original text.

Moreover, in one paragraph or sentence, one term may associates with many verbs, called verb argument, and errors would be easily occurred during dividing the original text. Hence, the PropBank notations (Kingsbury & Palmer, 2003) can be applied to the text abstract editing system of the present disclosure for enhancing the accuracy thereof.

In the application of the PropBank notations, the terms in the composed abstract may occurred verb arguments can be labelled. For an example, a sentence of fifth paragraph in the article of “Finding His Calling in His 70s: Calligrapher Wang Zhongtian” is stated as follow:
“He was reliable and hardworking, and apart from organizing teams and putting on matches, he would often be asked to resolve disputes, arrange VIP visits, and write speeches for his superior officers.”

The verb arguments in the paragraph can be listed as follow, and “V” means the term with verb argument:

First Verb arguments structure

| | |
|---|---|
| A1 | He |
| V | was |
| AM-PRD | reliable and hardworking |

Second Verb arguments structure

| | |
|---|---|
| V | organizing |
| A0 | teams |

Third Verb arguments structure

| | |
|---|---|
| V | putting |
| A1 | on matches |
| A0 | he |

Then, the paragraph can be checked that whether the term exist in the verb argument structures or not. Also, the term with verb argument in the paragraph can also be quantized by a calculating condition which for presenting a conceptual term frequency in paragraph (ctfp) as follow:

$$ctfp = \frac{{\sum }_{n = 1}^{pn} {ctf}_{n}}{pn}$$

### Wherein,

ctf represents the number of times that term appears in the verb argument structures;
pn represents the number of sentences that contain the concept c (can be considered as the substance, paragraph substance or paragraph related terms) in a paragraph p.

If the frequency of the concept appears in verb argument structures of sentences in a paragraph is high, the concepts have a major contribution for the meaning of the one paragraph. The ctfp value of the example is listed as follow:

| words | ${\sum }_{n = 1}^{pn} {ctf}_{n}$ | pn | ctfp |
|---|---|---|---|
| team | 2 | 1 | 2.0 |
| match | 2 | 1 | 2.0 |
| dispute | 2 | 2 | 1.0 |
| VIP | 2 | 1 | 2.0 |
| visit | 2 | 1 | 2.0 |
| speech | 2 | 1 | 2.0 |
| officer | 3 | 2 | 1.5 |

In the text abstract scoring system, the text abstract scoring method and the text abstract editing system of the present disclosure, many terms, phrases would be searched and provided, however, especially about the noun phrases, there are more information than simple nouns in text. For identifying the noun phrase, named entity recognition (NER) can be applied to the text abstract scoring system, the text abstract scoring method and the text abstract editing system of the present disclosure. NER is the information extraction task in Natural Language Processing (NLP). It aims to identify and classify mentions of people, organizations, locations, time, money and other named entities within text (Nothman, Ringland, Radford, Murphy, & Curran, 2013). Therefore, the phrases in the original text can be identified based on NER.

First, the n-gram is provided to extract the phrase combination. Second, NER tagger can be provided for searching the entities in the paragraph. The entities such as people, organizations and locations are considered very important in the text, so the importance of entities can be presented as scare and be calculated by the following condition:

Score(pⱼ)=Σₜ_{ᵢ}_{εf}_{ⱼ}w(tᵢ)+Σₜ_{ᵢ}_{εe}_{ⱼ}w(tᵢ)

wherein,
pⱼ represents the j-th phrase in the set of the phrases extracted by the regular expressions method and the phrases extracted by the NER method;
fⱼ represents the j-th phrase which comes from the subset by the regular expressions method;
eⱼ represents the j-th phrase which comes from the subset by the NER method; and
w(tᵢ) represents the term weight which comes from the Automatic Semantic labeling and Lexical Chains.

Therefore, the phrase with higher score can be considered as exemplar phrase in each paragraph.

It will be apparent to those skilled in the art that various modifications and variations can be made to the structure of the present invention without departing from the scope or spirit of the invention. In view of the foregoing, it is intended that the present invention cover modifications and variations of this invention provided they fail within the scope of the following claims.

What is claimed is:

1. A text abstract scoring system, comprising:
a text providing module, for providing an original text;
a text dividing module, for dividing the original text into a plurality of terms;
a searching module connected to a first external database, the searching module comprising:
a first searching module for searching a plurality of first related terms from the first external database according to each of the terms;
a choosing module connected to the searching module, the choosing module comprising;
a first calculating module for calculating a first related degree between each of the first related terms and each of the terms of the original text, wherein the first related terms corresponding to a maximum first related degree is a substance of the original text;
a receiving module, for receiving at least one user's text; and
a comparing module, for checking whether the user's text has the substance, and providing a comparing result.

2. The text abstract scoring system of claim 1, wherein,
the original text has a plurality of paragraphs;
the searching module further comprises a second searching module, wherein the second searching module is for searching a plurality of second related terms from the first external database according to the substance; and
a choosing module further comprises a second calculating module, wherein the second calculating module is for calculating a second related degree between each of the second related terms and the terms of each of the paragraphs, wherein in each paragraph the second related term corresponding to a maximum second related degree is a paragraph substance of the paragraph.

3. The text abstract scoring system of claim 1, wherein the user's text has a plurality of user's paragraphs, and the comparing module is for checking whether each of the user's paragraphs of the user's text has the paragraph substance, and providing a paragraph comparing result.

4. The text abstract scoring system of claim 3, wherein,
the searching module further comprises a third searching module for receiving the first related terms from the first searching module and the second related terms from the second searching module; and
a choosing module further comprises a third calculating module, wherein the third calculating module is for choosing the terms from the first related terms and the second related terms except the substance and the paragraph substances as a plurality of paragraph related terms.

5. The text abstract scoring system of claim 4, wherein the comparing module is for checking whether each of the user's paragraphs has the paragraph related terms, and providing a paragraph related terms comparing result.

6. The text abstract scoring system of claim 5, further comprising:
a score calculating module, for receiving the comparing result, the paragraph comparing result and the paragraph related terms comparing result, and calculating a user's text score.

7. The text abstract scoring system of claim 4, further comprising:
a mind map module, for receiving the substance, the paragraph substances and the paragraph related terms, and providing a term mind map.

8. The text abstract scoring system of claim 4, further comprising:
a lexical chain module connected to the choosing module and for classifying the paragraph related term from the third calculating module of the choosing module.

9. The text abstract scoring system of claim wherein the text dividing module further comprises:
a term identification module for identifying a language of the original text;
a tokenization module for dividing character streams of the original text into a plurality of pre-terms and classifying the pre-terms; and
a stemming module for certainly dividing the pre-terms into the terms of the original text.

10. A text abstract scoring method, comprising:
providing an original text, wherein the original text has a plurality of paragraphs;
dividing the original text into a plurality of terms;
searching a plurality of first related terms from the first external database according to each of the terms, and calculating a first related degree between each of the first related terms and each of the terms of the original text, wherein the first related terms corresponding to a maximum first related degree is a substance of the original text;
searching a plurality of second related terms from the first external database according to the substance, and calculating a second related degree between each of the second related terms and the terms of each of the paragraphs, wherein in each paragraph the second related term corresponding to a maximum second related degree is a paragraph substance of the paragraph;
choosing the terms from the first related terms and the second related terms except the substance and the paragraph substances as a plurality of paragraph related terms;
receiving at least one user's text; and
comparing whether the user's text has the substance, the paragraph substances and the paragraph related terms, and providing a comparing result.

11. The text abstract scoring method of claim 10, further comprising:
receiving the substance, the paragraph substances and the paragraph related terms, and providing a term mind map.

12. A text abstract editing system, comprising:
a text providing module, for providing an original text, wherein the original text has a plurality of paragraphs;
a text dividing module, for dividing the original text into a plurality of terms;
a first searching module, for searching a plurality of first related terms from the first external database according to each of the terms;
a first calculating module, for calculating a first related degree between each of the first related terms and each of the terms of the original text, wherein the first related terms corresponding to a maximum first related degree is a substance of the original text;
a second searching module, for searching a plurality of second related terms from the first external database according to the substance;
a second calculating module, for calculating a second related degree between each of the second related terms and the terms of each of the paragraphs, wherein in each paragraph the second related term corresponding to a maximum second related degree is a paragraph substance of the paragraph;
a sentence choosing module, for calculating a sentence related degree between each of a plurality of sentences of each paragraph and the paragraph substance thereof, wherein the sentence corresponding to a maximum sentence related degree is a main sentence of each paragraph; and
an abstract editing module, for composing the main sentence of each paragraph into an abstract, wherein a sequence of each main sentence in the abstract corresponds to a sequence of the paragraphs in the original text, and a title of the abstract is the substance.

13. The text abstract editing system of claim 12, wherein the text dividing module further comprises:
a term identification module for identifying a language of the original text;
a tokenization module for dividing character streams of the original text into a plurality of pre-terms and classifying the pre-terms; and
a stemming module for certainly dividing the pre-terms into the terms of the original text.
